(19) United States
(12) Patent Application Publication
(10) Pub. No.: US 2020/0034279 A1
(43) Pub. Date: Jan. 30, 2020

(54) DEEP MACHINE LEARNING IN SOFTWARE TEST AUTOMATION

(71) Applicant: SAP SE, Walldorf (DE)

(72) Inventors: Kumar SHIVAM, Patna (IN); Gokulkumar Selvaraj, Coimbatore (IN)

(21) Appl. No.: 16/043,399

(22) Filed: Jul. 24, 2018

(51) Int. Cl. G06F 11/36; G06N 3/08; G06N 5/04

(52) U.S. Cl. CPC G06F 11/3672; G06N 5/046; G06N 3/08

(57) ABSTRACT

The present disclosure involves systems, software, and computer implemented methods for deep machine learning in software test automation. One example method includes capturing images of a web page during successful executions of a test script that tests the web page. A convolutional neural network (CNN) is trained using the captured images. The CNN is configured to determine whether an image input matches previously captured images. A determination is made that a particular execution of the test script has failed. A first image of the web page is captured at a time of the test script execution failure. The first image is provided to the CNN. An output of the CNN is received that indicates whether the first image matches previously captured images. A source of the test script execution failure is determined based on the output received from the CNN.

### TECHNICAL FIELD

The present disclosure relates to computer-implemented methods, software, and systems for deep machine learning in software test automation.

### BACKGROUND

A test script in software testing is a set of instructions that can be performed on a system under test to determine whether the system functions as expected. There are various means for executing test scripts. For example, test scripts can include manual steps that are manually performed by a tester. For example, a tester can load a particular web page in a browser and interact with various elements on the web page and determine whether observed results match expected results. As another example, test scripts can be automatically executed by a testing infrastructure, and comparison of expected to actual results can be automatically performed.

### SUMMARY

The present disclosure involves systems, software, and computer implemented methods for deep machine learning in software test automation. One example method includes capturing images of a web page during successful executions of a test script that tests the web page. A convolutional neural network (CNN) is trained using the captured images. The CNN is configured to determine whether an image input matches previously captured images. A determination is made that a particular execution of the test script has failed. A first image of the web page is captured at a time of the test script execution failure. The first image is provided to the CNN. An output of the CNN is received that indicates whether the first image matches previously captured images. A source of the test script execution failure is determined based on the output received from the CNN

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for deep machine learning in software test automation.

FIG. 2 is a flowchart of an example method for diagnosing a test script failure.

FIG. 3 is a flowchart of an example method for diagnosing a test script failure.

FIG. 4 is a block diagram illustrating an example system for image processing using a CNN (Convolutional Neural Network).

FIG. 5A is an example image input.

FIG. 5B is an example convoluted feature.

FIG. 6 is a block diagram illustrating an example system for web page analysis.

### DETAILED DESCRIPTION

With advancements in cloud computing, the pace of delivery of software and cloud offerings has increased significantly and competition between vendors can be intense. However, cloud offerings should be properly tested before being delivered so that delivered products are functional and of high quality. In a fast-paced development environment, continuous delivery approaches can be employed, in which software delivery, including testing and quality checks, is automated and performed in a continuous (or near-continuous) mode. A continuous (or near-continuous) software delivery mode can be achieved by automating a deployment pipeline, which can connect software changes done by developers to releases of a software product to end users. A deployment pipeline generally includes intensive testing of software before the software is delivered. Such intensive testing can include software testing automation.

Automation approaches can be used to automate the process of releasing software changes (e.g., fixes, innovations) in a continuous delivery model. Automated software testing can support and enable continuous maintenance and quality and efficiency improvements as a pace of development continues to increase. Despite advantages of software test automation, creation of scripts to be automated can include manual human effort, which can result in introduction of errors in automated test scripts. Diagnosing and fixing test script errors can be a challenge for achieving and sustaining successful software test automation. Test script errors can be introduced as scripts are adjusted to account for ongoing changes in the application being tested.

When a test script fails it can be challenging and resource-costly to analyze the factors which led to the failure. A significant amount of time can be required to determine whether the issue is due to a script error or an application error. For example, a test script may fail due to a failed attempt to identify a web element with which the test script is to interact, on a web page being tested. Possible reasons for the failure can be an application issue such as the web element incorrectly not actually being in the web page being tested. As another example, the web element may be on the page but a test script issue (e.g., an incorrectly-coded test script statement) may result in generation of an error that causes the test script to fail.

To assist with test script error resolution, deep learning approaches can be used in which a machine learning engine is trained to determine a cause of a test script error. Deep learning approaches are artificial intelligence (AI) functions that imitate the workings of the human brain in processing data and creating patterns for use in decision making. Deep learning is a subset of machine learning in AI that has networks which are capable of learning unsupervised from data that is unstructured or unlabeled. Deep learning can use neural networks, which are computational models that work in a similar way to the neurons in the human brain. Each neuron takes an input, performs operation(s), and passes processing output(s) to the following neuron. Neural networks used for test script error resolution can include the use of a convolutional neural network (CNN). A CNN is a special type of neural networks that includes an initial convolutional layer.

A deep learning engine can use a CNN to determine whether a test script that fails has accessed a correct web page with respect to an attempted test. Determining whether the test script has accessed a correct web page can help determine whether the test script has failed due to an application issue or a test script issue. The described deep learning approaches can be used for other use cases that involve identification of a correct web page for a given context.

If the deep learning approach determines that the test script failure is due to an application issue, testers can be notified and can report the application issue to the development team. Knowing that the test script failure is due to an application issue can result in significant time and resource savings for testing of the software, since testers can avoid needlessly trying to find a non-existent issue with the test script itself. Alternatively, if the deep learning approach determines that the test script failure is due to a test script issue, testers can know to focus their troubleshooting efforts on fixing the test script.

The use of deep learning to assist with test script error resolution can result in less manual effort by software testers, a faster time to reach test script error resolution (as compared to manual efforts), and a higher accuracy of error resolution (e.g., a machine learning approach may successfully determine an actual cause of a test script error at a higher percentage than manual approaches). Faster and more accurate test script error resolution can result in testers being able to spend more time generating and running more software tests, which can result in higher quality and/or a faster delivery of a software release.

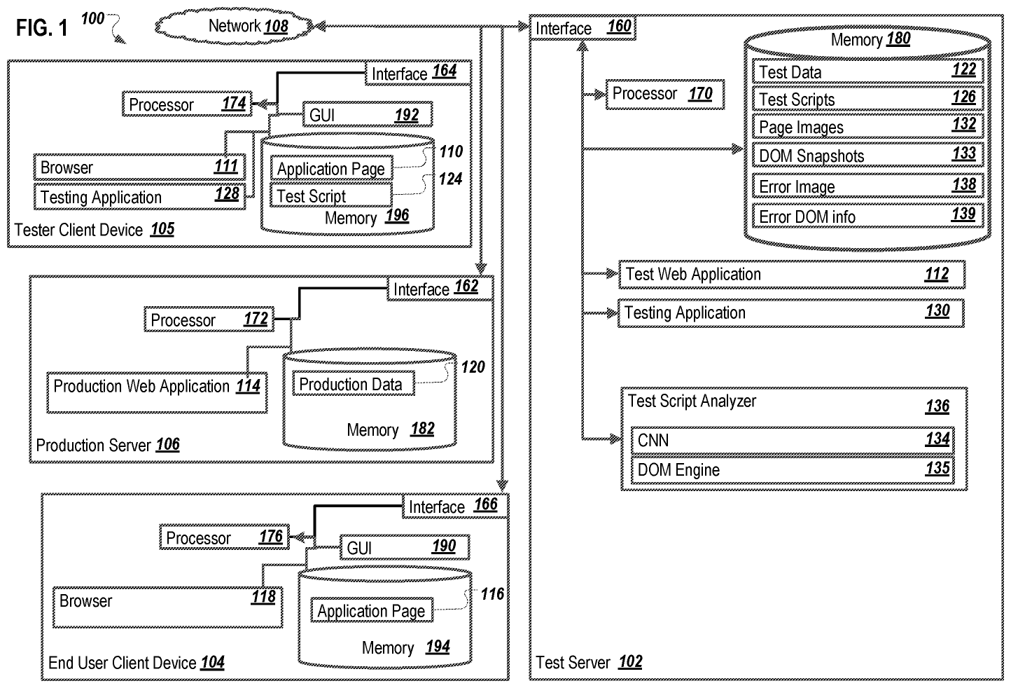

FIG. 1 is a block diagram illustrating an example system 100 for deep machine learning in software test automation. Specifically, the illustrated system 100 includes or is communicably coupled with a test server 102, an end user client device 104, a tester client device 105, a production server 106, and a network 108. Although shown separately, in some implementations, functionality of two or more systems or servers may be provided by a single system or server. In some implementations, the functionality of one illustrated system or server may be provided by multiple systems or servers. For example, although illustrated as a single server 102, the system 100 can include multiple application servers, a database server, a centralized services server, or some other combination of systems or servers.

A tester can use the tester client device 105 to test an application page 110 in a browser 111 (or in a testing application (not shown). The application page 110 can be generated by a test web application 112 running on the test server 102 (or by a production web application 114 running on the production server 106). The application page 110 may be being tested for future execution as an application page 116 in a browser 118 on the end user client device 104. The application page 116 can be provided by the production web application 114 and can use production data 120. The application page 110 can use test data 122 that is provided by the test server 102 (or manually entered by the tester).

The tester can run a test script 124 on the tester client device 105. The test script 124 can be retrieved from test scripts 126 stored in the test server 102. The test script 124 can be run in the browser 111 and/or in a testing application 128. The test script 124 is configured to test the application page 110. The testing application 128 may be a client version of a testing application 130 provided by the test server 102, or may be a standalone application running on the tester client device 105.

When the test script 124 is ran, the testing application 128 (or the tester) can capture images of the application page 110 at the time of the test script 124 execution. Captured page images can be sent to and stored in the test server 102, as captured page images 132. Additionally, the testing application 128 can capture DOM (Document Object Model) information for the application page 110 that describes web page elements and properties of the web page elements. The captured DOM information can be stored as DOM snapshots 133.

The captured page images 132 can be provided to a CNN 134 for training of the CNN 134. The CNN 134 can be configured to determine whether an image input matches previously captured page images. The DOM snapshots can be provided to a DOM engine 135 which is configured to identify static elements of the application page 110 based on the DOM snapshots 133.

If an error occurs during execution of the test script 124, an image of the application page 110 can be captured and stored as an error image 138 and current DOM information can be captured and stored as error DOM information 139 (e.g., an image and the current DOM information for the application page 110 at the time of the test script error, respectively, can be captured and stored at the test server 102). A test script analyzer 136 can use the CNN 134 to process the error image 138 captured at the time of the test script error and determine whether the error image 138 matches the previously captured page images 132. The CNN 134 can determine whether the test script 124 was accessing a correct/expected page (e.g., whether the application page 110 that is rendered in the browser 111 appears to be a correct, or same page, for a state of the web application at the time of the test, as has been displayed in the browser 111 during multiple, previous successful executions of the test script 124).

If the CNN 134 determines that the test script 124 was accessing the expected page, the test script analyzer 134 can determine that the failure of the test script 124 is a test script issue, rather than an application issue. A notification of the test-script issue determination can be presented in the testing application 128. The tester (or the test script analyzer 134) can generate an incident report, to track the test script issue and initiate resolution of the test script issue, by the tester and/or others on a testing team.

If the CNN 134 determines that the test script 124 was not accessing the expected page (e.g., if the error image 138 does not match previously captured page images 132), the test script analyzer 134 can determine that the test script failure is an application issue. The application page 110 may not have been generated correctly and/or may not have rendered properly in the browser 111, for example. The tester (or the test script analyzer 134) can generate an application incident report, to track the application issue. The application incident report can be automatically provided to the application development team.

If the output from the CNN 134 is inconclusive as to whether the error image 138 matches the previously captured images 132, the DOM engine 135 can compare the error DOM info 139 to the DOM snapshots 133 to determine whether the test script 124 accessed the correct page. Static web page elements identified in the DOM snapshots can be compared to static web page elements identified in the error DOM info 139 to determine whether the error DOM info 139 matches the DOM snapshots 133. If the error DOM info 139 matches the DOM snapshots 133, the DOM engine 135 can determine that the test script accessed the correct page and that the test script execution failure is a test script issue. If the error DOM info 139 does not match the DOM snapshots 133, the DOM engine 135 can determine that the test script did not access the correct page and that the test script execution failure is an application issue.

As used in the present disclosure, the term “computer” is intended to encompass any suitable processing device. For example, although FIG. 1 illustrates a single test server 102, a single end-user client device 104, a single tester client device 105, and a single production server 106, the system 100 can be implemented using a single, stand-alone computing device, two or more test servers 102, two or more production servers 106, two or more end-user client devices 104, two or more administrator client devices 105, etc. Indeed, the test server 102, the production server 106, the tester client device 105, and the client device 104 may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the test server 102, the production server 106, the tester client device 105, and the client device 104 may be adapted to execute any operating system, including Linux, UNIX, Windows, Mac OS®, Java™, Android™, iOS or any other suitable operating system. According to one implementation, the production server 106 and/or the test server 102 may also include or be communicably coupled with an e-mail server, a Web server, a caching server, a streaming data server, and/or other suitable server.

Interfaces 160, 162, 164, and 166 are used by the test server 102, the production server 106, the tester client device 105, and the client device 104, respectively, for communicating with other systems in a distributed environment—including within the system 100—connected to the network 108. Generally, the interfaces 160, 162, 164, and 166 each comprise logic encoded in software and/or hardware in a suitable combination and operable to communicate with the network 108. More specifically, the interfaces 160, 162, 164, and 166 may each comprise software supporting one or more communication protocols associated with communications such that the network 108 or interface's hardware is operable to communicate physical signals within and outside of the illustrated system 100.

The test server 102, the production server 106, the tester client device 105, and the client device 104, each respectively include one or more processors 170, 172, 174, or 176. Each processor in the processors 170, 172, 174, and 176 may be a central processing unit (CPU), a blade, an application specific integrated circuit (ASIC), a field-programmable gate array (FPGA), or another suitable component. Generally, each processor in the processors 170, 172, 174, and 176 executes instructions and manipulates data to perform the operations of a respective computing device.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The test server 102 and the production server 106 respectively include memory 180 or memory 182. In some implementations, the test server 102 and/or the production server 106 include multiple memories. The memory 180 and the memory 182 may each include any type of memory or database module and may take the form of volatile and/or non-volatile memory including, without limitation, magnetic media, optical media, random access memory (RAM), read-only memory (ROM), removable media, or any other suitable local or remote memory component. Each of the memory 180 and the memory 182 may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the respective computing device.

The end-user client device 104 and the tester client device 105 may each be any computing device operable to connect to or communicate in the network 108 using a wireline or wireless connection. In general, each of the end-user client device 104 and the tester client device 105 comprises an electronic computer device operable to receive, transmit, process, and store any appropriate data associated with the system 100 of FIG. 1. Each of the end-user client device 104 and the tester client device 105 can include one or more client applications, including the testing application 128 or the browser 111, or the browser 118, respectively. A client application is any type of application that allows a client device to request and view content on the client device. In some implementations, a client application can use parameters, metadata, and other information received at launch to access a particular set of data from the test server 102 or the production server 106. In some instances, a client application may be an agent or client-side version of the one or more enterprise applications running on an enterprise server (not shown).

Each of the end-user client device 104 and the tester client device 105 is generally intended to encompass any client computing device such as a laptop/notebook computer, wireless data port, smart phone, personal data assistant (PDA), tablet computing device, one or more processors within these devices, or any other suitable processing device. For example, the end-user client device 104 and/or the tester client device 105 may comprise a computer that includes an input device, such as a keypad, touch screen, or other device that can accept user information, and an output device that conveys information associated with the operation of the test server 102, or the client device itself, including digital data, visual information, or a graphical user interface (GUI) 190 or 192, respectively.

The GUI 190 and the GUI 192 each interface with at least a portion of the system 100 for any suitable purpose, including generating a visual representation of the testing application 128 or the browser 111, or the browser 118, respectively. In particular, the GUI 190 and the GUI 192 may each be used to view and navigate various Web pages. Generally, the GUI 190 and the GUI 192 each provide the user with an efficient and user-friendly presentation of business data provided by or communicated within the system. The GUI 190 and the GUI 192 may each comprise a plurality of customizable frames or views having interactive fields, pull-down lists, and buttons operated by the user. The GUI 190 and the GUI 192 each contemplate any suitable graphical user interface, such as a combination of a generic web browser, intelligent engine, and command line interface (CLI) that processes information and efficiently presents the results to the user visually.

Memory 194 and memory 196 respectively included in the end-user client device 104 or the tester client device 105 may each include any memory or database module and may take the form of volatile or non-volatile memory including, without limitation, magnetic media, optical media, random access memory (RAM), read-only memory (ROM), removable media, or any other suitable local or remote memory component. The memory 194 and the memory 196 may each store various objects or data, including user selections, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the client device 104.

There may be any number of end-user client devices 104 and administrator client devices 105 associated with, or external to, the system 100. Additionally, there may also be one or more additional client devices external to the illustrated portion of system 100 that are capable of interacting with the system 100 via the network 108. Further, the term “client,” “client device,” and “user” may be used interchangeably as appropriate without departing from the scope of this disclosure. Moreover, while client device may be described in terms of being used by a single user, this disclosure contemplates that many users may use one computer, or that one user may use multiple computers.

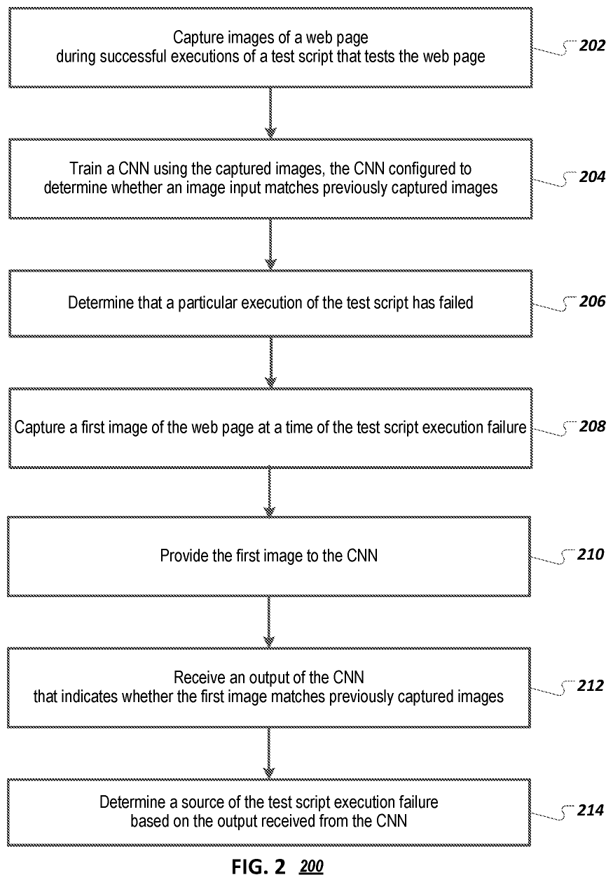

FIG. 2 is a flowchart of an example method for diagnosing a test script failure. It will be understood that method 200 and related methods may be performed, for example, by any suitable system, environment, software, and hardware, or a combination of systems, environments, software, and hardware, as appropriate. For example, one or more of a client, a server, or other computing device can be used to execute method 200 and related methods and obtain any data from the memory of a client, the server, or the other computing device. In some implementations, the method 200 and related methods are executed by one or more components of the system 100 described above with respect to FIG. 1. For example, the method 200 and related methods can be executed by the test script analyzer 136 of FIG. 1.

At 202, images of a web page are captured during successful executions of a test script that tests the web page. The web page can be part of a web-based application. The captured images can be stored in a repository. The captured images can be a collection of images can share common static items that are always (or often) included in the web page at the stage of the web application at which the test script is executed. Other portions of the web page can include varying items, which may depend on an application state, input data that was provided to the web page at or before the stage of the web application at which the test script is executed, and/or output data generated by the application at or before the stage of the web application at which the test script is executed. For example, some presentation areas of the web page may always be present in the page at a particular stage of the application, and some areas of the web page may be output areas which may have different contents after different executions of the web page. Web page images can be captured during test script and/or application development as well as during test script executions performed on production versions of the application.

In addition to capturing web page images, DOM information for the web page can be captured during successful executions of a test script that tests the web page. For example, script code can be included in the web page that identifies and captures page elements and page element properties for each item included in the web page.

At 204, a CNN is trained using the captured images. The CNN is configured to determine whether an image input matches previously captured images. Web page images can vary, as described above, but can still represent a same output stage (e.g., same page) of a web application in a particular state. The CNN can be trained to determine whether a given web page image represents a same output state of a web application as other web page images that were captured in a same application stage.

The CNN can also be trained using the page element and page element property information that has been collected from the DOM information. The CNN can be trained for statistical pattern recognition of DOM elements. The CNN can learn which items of the page are static items that generally appear each time the page is rendered. Other items of the page may vary, based on application input, the state of the application at a given point in time, the state of data in an application database, etc.

At 206, a determination is made that a particular execution of the test script has failed. For example, the test script can generate an error condition or an error message. In some implementations, a test harness catches an error that is generated by the test script and notifies a tester of the captured error. The test script can fail due to becoming unresponsive (e.g., for at least a certain period of time), attempting to access a web page element that is not actually on the page, or due to other reasons. As another example, a tester may believe, through observation, that a test script has generated a false positive result and the tester can manually determine that the particular execution of the test script has failed.

At 208, a first image of the web page is captured at a time of the test script execution failure. Additionally, DOM information for the web page can be captured at the time of the test script execution failure.

At 210, the first image is provided to the CNN as an input to the CNN. The CNN can process the first image to determine whether first image matches previously captured images. CNN processing is described in more detail below.

At 212, an output of the CNN is received that indicates whether the first image matches previously captured images. The output can be a likelihood (e.g., a probability percentage indicating how likely the first image matches previously captured images).

At 214, a source of the test script execution failure is determined based on the output received from the CNN. The source of the test script execution failure can be the test script or the web-based application. If the output indicates that the first image matches previously captured images, a determination can be made that the test script was accessing a correct web page and that the test script execution failure is a test script issue. An incident report can be generated and provided to a testing team to notify the testing team of the test script issue.

If the output indicates that the first image does not match previously captured images, a determination can be made that the test script execution failure is a web page application issue. The application may not have been generated properly or may not be rendering properly, for example, which may have caused the test script failure. An incident report can be generated and provided to an application development team to notify the application development team of the web page application issue.

If the output is inconclusive as to whether the first image matches previously captured images, analysis of the DOM data captured at the time of the test script execution failure can be performed to determine whether the test script was accessing a correct web page. DOM data analysis is described in more detail below.

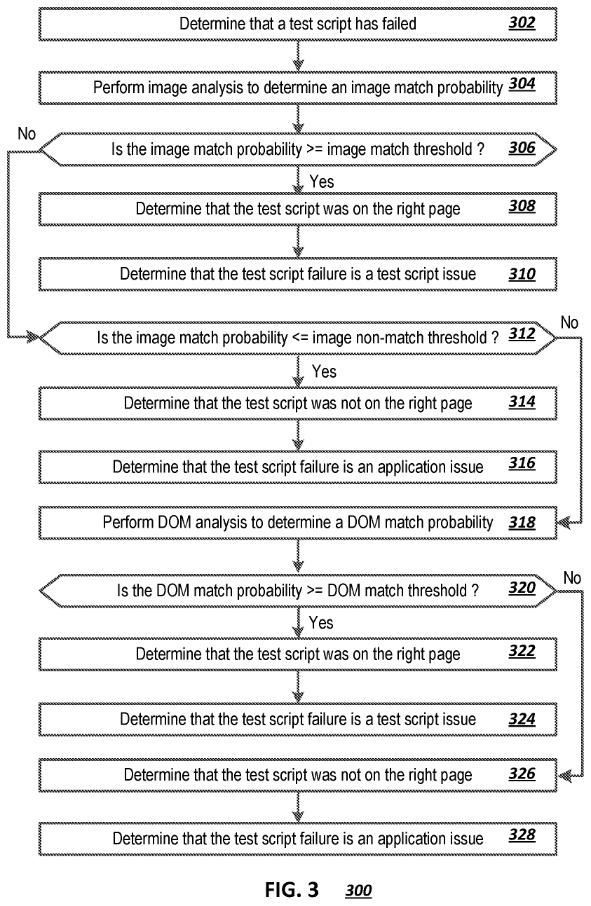

FIG. 3 is a flowchart of an example method for diagnosing a test script failure. It will be understood that method 300 and related methods may be performed, for example, by any suitable system, environment, software, and hardware, or a combination of systems, environments, software, and hardware, as appropriate. For example, one or more of a client, a server, or other computing device can be used to execute method 300 and related methods and obtain any data from the memory of a client, the server, or the other computing device. In some implementations, the method 300 and related methods are executed by one or more components of the system 100 described above with respect to FIG. 1. For example, the method 300 and related methods can be executed by the test script analyzer 136 of FIG. 1.

At 302, a determination is made that a test script has failed. As described above, the test script can generate an error message, the test script can become unresponsive, or a tester may believe, through observation, that a test script has generated a false positive result.

At 304, image analysis is performed to determine an image match probability that indicates a likelihood that the test script was accessing a correct web page. Image analysis can be performed using a CNN, as described below.

At 306, a determination is made as to whether the image match probability is greater than or equal to an image match threshold. The image match threshold can be a first predetermined probability threshold (e.g., 30%).

If the image match probability is greater than or equal to the image match threshold, a determination is made, at 308, that the test script was accessing the correct web page (e.g., “on the right page”). That is, if the image match probability is high enough, the method 300 can determine, without further processing, that the test script was accessing the correct web page.

At 310, based on determining that the test script was on the right page, a determination can be made that the test script failure is a test script issue. Testers can be notified and can focus efforts on troubleshooting the test script, for example.

If, at 306, the image match probability is not greater than or equal to the image match threshold, a determination is made, at 312, as to whether the image match probability is less than or equal to an image non-match threshold. The image non-match threshold can be a second predetermined probability threshold (e.g., 30%), that is lower than the first predetermined probability threshold.

If the image match probability is less than or equal to the image non-match threshold, a determination is made, at 314, that the test script was not on the right page. That is, if the image match probability is low enough, the method 300 can determine, without further processing, that the test script was not accessing the correct web page.

At 316, based on determining that the test script was not on the right page, a determination can be made that the test script failure is an application issue. Testers can focus efforts on communicating with the development team that an application issue has been found.

If, at 312, the image match probability is not less than or equal to the image non-match threshold, DOM analysis is performed, at 318, to determine a DOM match probability. DOM analysis can be performed if the image analysis is inconclusive as to whether the test script was on the right page. Upon reaching step 318, the method 300 has determined that the image match probability was neither highly indicating a match or a non-match. The DOM analysis can be a second stage to be performed when the image analysis results are inconclusive.

DOM analysis can include comparing current DOM data captured for the web page at the time of the test script execution failure to historical DOM data captured for the web page during successful test script executions. The current DOM data and the historical DOM data can be analyzed to identify static elements in each set of DOM data. A DOM match probability can be calculated that indicates a level of match between the static elements in the current DOM data and the static elements in the historical DOM data.

At 320, a determination is made as to whether the DOM match probability is greater than or equal to a DOM match threshold. The DOM match threshold can be a third predetermined probability threshold (e.g., 80%).

If the DOM match probability is greater than or equal to the DOM match threshold, a determination is made, at 322, that the test script was accessing the correct web page.

At 324, based on determining that the test script was on the right page, a determination can be made that the test script failure is a test script issue. Testers can focus efforts on troubleshooting the test script, for example.

If, at 320, the DOM match probability is not greater than or equal to the DOM match threshold, a determination is made, at 326, that the test script was not accessing the correct web page.

At 328, based on determining that the test script was not on the right page, a determination can be made that the test script failure is an application issue. Testers can focus efforts on communicating with the development team that an application issue has been found.

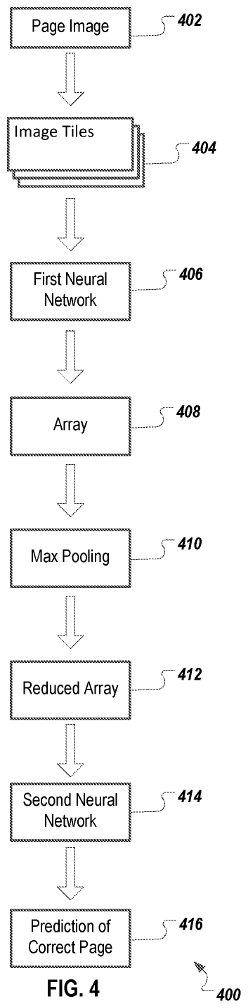

FIG. 4 is a block diagram illustrating an example system 400 for image processing using a CNN. An image 402 of a web page that was captured when a test script error was detected is broken down into a set of multiple, same-sized image tiles 404. The image tiles 404 are provided an inputs to a first neural network 406.

The first neural network 406 processes the image tiles 404. The first neural network 406 can be a CNN that includes convolutional layers. Convolution is a mathematical operation that's used in signal processing to filter signals, find patterns in signals, etc. In a convolutional layer, neurons apply a convolution operation to neuron inputs, and can be referred to as convolutional neurons. A parameter in a convolutional neuron can be a filter size.

The first neural network 406 can include a layer with filter size 5×5×3, for example. The image tiles 404 input can be fed to convolutional neuron and can be an input image of size of 32×32 with 3 channels. As an example, a 5×5×3 (3 for number of channels in a colored image) sized portion from the image tiles 404 can be processed by performing a convolution operation (e.g., dot product, matrix to matrix multiplication) with a convolutional filter w. The convolutional filter w can be selected so that a third dimension of the filter is equal to the number of channels in the input (e.g., the dot product can be a matrix multiplication of a 5×5×3 portion with a 5×5×3 sized filter). The example convolution operation can result in a single number as output. A bias b can be added to the output.

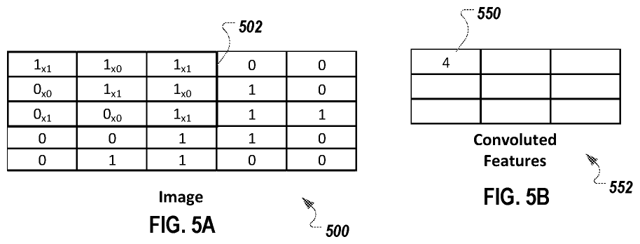

The output of the first neural network 406 is an array 408. For example, the convolutional filter can be slid over a whole input image to calculate outputs across the image as illustrated by a schematic image 500 in FIG. 5A. For example, a window 502 can be slid across the image 500 by one pixel at a time (or by multiple pixels). Each sliding of the window 502 can produce an output (e.g., an output 550 can be included in convoluted features 552, with the output 550 corresponding to the window 502). The number of pixels to slide the window 502 by can be referred to as a stride. After sliding the window 502 across the image 500, multiple outputs can be produced and concatenated into two dimensions, which can produce the array 408 as an activation map of size 28×28, for example.

After each convolution, a convolution output may be reduced in size as compared to the convolution input (e.g., after a first convolution, a 32×32 array be reduced to a 28×28 array). To avoid a final output becoming too small, zeros can be added on the boundary of an input layer such that the output layer is the same size as the input layer. For example, a padding of size two can be added on both sides of an input layer, which can result in an output layer having a size of 32×32×6. In general, if an input layer has a of size N×N, a filter has a size of F, S is used as a stride, and a pad of size P is added to the input layer, the output size can be computed as (N−F+2P)/S+1.

The first neural network 406 can reduce image processing by filtering connections between layers by proximity. In a given layer, rather than linking every input to every neuron, the first neural network 406 can intentionally restrict connections so that any one neuron accepts the inputs only from a small subsection (e.g., 5×5 or 3×3 pixels) of a preceding layer. Hence, each neuron can be responsible for processing only a certain portion of an image. Neurons processing only a certain portion of an image can model how individual cortical neurons function in a biological brain. Each cortical neuron generally responds to only a small portion of a complete visual field, for example.

The array 408 can be reduced by a max-pooling process 410 to create a reduced array 412. Max-pooling can be used as an efficient, non-linear method of down-sampling the array 408, for reduced computation by a second neural network 414. The max-pooling process 410 can include using a pooling layer after a convolutional layer to reduce a spatial size (e.g., width and height, but not depth) of the array 408. Max-pooling can reduce computation by reducing a number of parameters, thereby reducing computation. Max-pooling can include taking a filter of size F×F and applying a maximum operation over a F×F sized portion of the image. If an input is of size w1×h1×d1 and the size of a filter is F×F with stride of S, then output sizes w2×h2×d2 can be calculated as w2=(w1−F)/S+1, h2=(h1−F)/S+1, and d2=d1. If max-pooling uses a filter of size 2×2 with a stride of 2, for example, the max-pooling process 410 can reduce an input size by half.

The reduced array 412 is provided as an input to the second neural network 414. The second neural network 412 determines and outputs a prediction 416 that indicates whether the page image 402 matches a previously captured page image. The prediction 416 can be produced by an output layer of the second neural network 414. Each neuron in the second neural network 414 can perform a calculation of y=x·w+b, where y is an output, x is an input, w is a weight which is set during training, and b is a bias which is set during training. The output layer can get, as inputs, other layers' outputs, and the output of the output layer (e.g., the prediction 416) can be a probability that the page image 402 matches a previously captured page image. Although the second neural network 416 is described as a different network than the first neural network 406, in some implementations, the second neural network 414 is included in the first neural network 406 as additional layers of the first neural network 406.

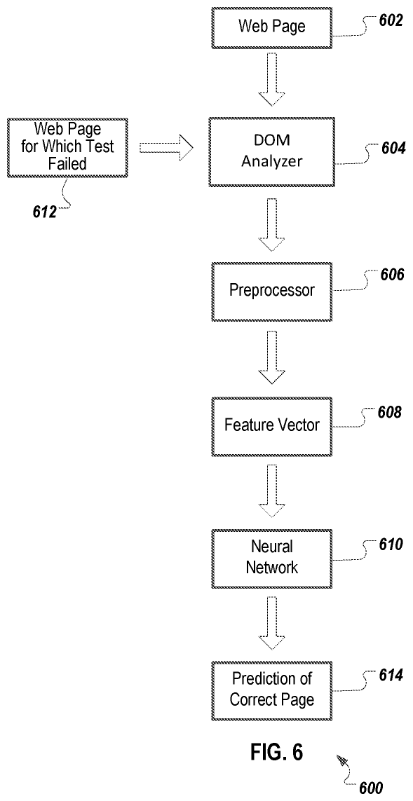

FIG. 6 is a block diagram illustrating an example system 600 for web page analysis. A web page 602 is analyzed by a DOM analyzer 604. The DOM analyzer 604 can receive the web page 602 and can process the web page 602 using scripting code. In some implementations, the scripting code is embedded in the web page 602. The DOM analyzer 604 can identify DOM elements (e.g., web page elements and properties) included in the web page 602.

The DOM analyzer 604 can provide the DOM information to a preprocessor 606. The preprocessor 606 can process the DOM information to normalize attribute values, for example, such as by performing stemming operations, removing stop words, etc., to produce normalized DOM information.

The preprocessor 606 can create a feature vector 608 from the normalized DOM information. The feature vector 608 can represent the attribute values that are included in the web page 602. The feature vector 602 can be provided to a neural network 610 to train the neural network 610.

Different versions of the web page 602 can be processed by the DOM analyzer 604, to produce different DOM information for processing by the preprocessor 606, to produce different feature vectors 608. Each of the different feature vectors 608 can be provided to the neural network 610 for training the neural network 610. The different versions of the web page 602 can be results of different renderings of a source web page at different points in time, by one or more users. A given rendering of the web page 602 may represent a particular web application state, for example. The neural network 610 can be a feed-forward neural network that is configured to determine aspects of the web page 602 that are static across different renderings of the web page 602 (e.g., to perform statistical pattern recognition of DOM elements).

After the neural network 610 has been trained, a web page 612 for which a test has failed can be provided as an input to the DOM analyzer 604. The DOM analyzer 604 can determine DOM information for the web page 612. The preprocessor 606 can produce a feature vector 608 for the web page 612 based on the DOM information for the page 612. The feature vector 608 for the web page 612 can be provided to the neural network 610. The neural network 610 can determine a prediction output 614 that determines whether the web page 612 is a correct (e.g., expected) page for the test. The prediction output 614 can represent a confidence that the static elements of the web page 612 match static elements of versions of the web page 602 that were used to train the neural network 610.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method, comprising:
capturing images of a web page during successful executions of a test script that tests the web page;
training a convolutional neural network (CNN) using the captured images, the CNN configured to determine whether an image input matches previously captured images;
determining that a particular execution of the test script has failed;
capturing a first image of the web page at a time of a test script execution failure;
providing the first image to the CNN;
receiving an output of the CNN that indicates whether the first image matches previously captured images; and
determining a source of the test script execution failure based on the output received from the CNN.

2. The method of claim 1, further comprising creating an incident report based on the output of the CNN and the determined source of the test script execution failure.

3. The method of claim 2,
wherein determining a source of the test script execution failure comprises determining, based on the output indicating that the first image matches previously captured images, that the test script was accessing a correct web page and that the test script execution failure is a test script issue; and
wherein creating the incident report includes notifying a testing team of the test script issue.

4. The method of claim 2,
wherein determining a source of the test script execution failure comprises determining, based on the output indicating that the first image does not match a previously captured image, that the test script execution failure is a web page application issue; and
wherein creating the incident report includes notifying an application development team of the web page application issue.

5. The method of claim 1, further comprising, based on the output being inconclusive as to whether the first image matches previously captured images, performing an analysis of document object model (DOM) data to determine whether the test script was accessing a correct web page.

6. The method of claim 5, wherein a first set of DOM data is captured during the successful executions of the test script and a second set of DOM data is captured at a time of the test script execution failure.

7. The method of claim 6, wherein the analysis of DOM data comprises determining static elements in the first set of DOM data and the second set of DOM data.

8. The method of claim 7, wherein the analysis of DOM data comprises comparing the static elements in the first set of DOM data to the static elements in the second set of DOM data to determine whether the test script was accessing the correct web page.

9. The method of claim 1, wherein the first image is broken down into a set of multiple image tiles before being provided to the CNN.

10. The method of claim 9, wherein the CNN is configured to use max-pooling to reduce processing.

11. A system comprising:
one or more computers; and
a computer-readable medium coupled to the one or more computers having instructions stored thereon which, when executed by the one or more computers, cause the one or more computers to perform operations comprising:
capturing images of a web page during successful executions of a test script that tests the web page;
training a convolutional neural network (CNN) using the captured images, the CNN configured to determine whether an image input matches previously captured images;
determining that a particular execution of the test script has failed;
capturing a first image of the web page at a time of a test script execution failure;
providing the first image to the CNN;
receiving an output of the CNN that indicates whether the first image matches previously captured images; and
determining a source of the test script execution failure based on the output received from the CNN.

12. The system of claim 11, the operations further comprising creating an incident report based on the output of the CNN and the determined source of the test script execution failure.

13. The system of claim 12,
wherein determining a source of the test script execution failure comprises determining, based on the output indicating that the first image matches previously captured images, that the test script was accessing a correct web page and that the test script execution failure is a test script issue; and
wherein creating the incident report includes notifying a testing team of the test script issue.

14. The system of claim 12,
wherein determining a source of the test script execution failure comprises determining, based on the output indicating that the first image does not match a previously captured image, that the test script execution failure is a web page application issue; and
wherein creating the incident report includes notifying an application development team of the web page application issue.

15. The system of claim 11, wherein based on the output being inconclusive as to whether the first image matches previously captured images, the operations further comprise performing an analysis of document object model (DOM) data to determine whether the test script was accessing a correct web page.

16. A computer program product encoded on a non-transitory storage medium, the product comprising non-transitory, computer readable instructions for causing one or more processors to perform operations comprising:
capturing images of a web page during successful executions of a test script that tests the web page;
training a convolutional neural network (CNN) using the captured images, the CNN configured to determine whether an image input matches previously captured images;
determining that a particular execution of the test script has failed;
capturing a first image of the web page at a time of a test script execution failure;
providing the first image to the CNN;
receiving an output of the CNN that indicates whether the first image matches previously captured images; and
determining a source of the test script execution failure based on the output received from the CNN.

17. The computer program product of claim 16, the operations further comprising creating an incident report based on the output of the CNN and the determined source of the test script execution failure.

18. The computer program product of claim 17,
wherein determining a source of the test script execution failure comprises determining, based on the output indicating that the first image matches previously captured images, that the test script was accessing a correct web page and that the test script execution failure is a test script issue; and
wherein creating the incident report includes notifying a testing team of the test script issue.

19. The computer program product of claim 17,
wherein determining a source of the test script execution failure comprises determining, based on the output indicating that the first image does not match a previously captured image, that the test script execution failure is a web page application issue; and
wherein creating the incident report includes notifying an application development team of the web page application issue.

20. The computer program product of claim 16, wherein based on the output being inconclusive as to whether the first image matches previously captured images, the operations further comprise performing an analysis of document object model (DOM) data to determine whether the test script was accessing a correct web page.
